(19) United States
(12) Patent Application Publication
(10) Pub. No.: US 2022/0077692 A1
(43) Pub. Date: Mar. 10, 2022

(54) BATTERY SYSTEMS DEEP SLEEP WAKE-UP FEATURE

(71) Applicant: CHIPPEWA AEROSPACE, INC., CONWAY, SC (US)

(72) Inventors: Charles T. Myers, Myrtle Beach, SC (US); Richard J. Lukso, Tucson, AZ (US)

(21) Appl. No.: 17/463,895

(22) Filed: Sep. 1, 2021

Related U.S. Application Data
(60) Provisional application No. 63/074,610, filed on Sep. 4, 2020.

(51) Int. Cl. H02J 7/00; H01M 10/42; H01M 10/44

(52) U.S. Cl. CPC H02J 7/005; H02J 7/0016; H02J 7/00308; G01P 15/18; H01M 10/4257; H01M 10/441; H02J 7/00712

(57) ABSTRACT

A smart battery monitoring method and system having a deep sleep wake up feature including a string of battery cells (providing 12-volt dc output), a built-in charger and battery health monitor sub-circuit connected to a deep sleep sub-circuit. Each string of battery cells is connected to a mosfit at its output to allow each string to output their voltage and current and at the same time isolating each from another so that reverse current cannot take place. A battery charger is connected to each module. A controller/monitor balances control of the discharge from each battery cell. The smart battery circuit is connected to a deep sleep sub-circuit incorporating a vibration and/or motion detector allowing the smart battery circuit to enter into and out of deep sleep automatically. The battery modules are in parallel and can be additive, as needed, to supply the amount of current required for the power rating of the battery.

The contents of Provisional application U.S. Ser. No. 63/074,610 filed Sep. 4, 2020, on which the present application is based and benefit claimed under 35 U.S.C. § 119(e), is herein incorporated by reference.

### BACKGROUND OF THE INVENTION

### 1. Field of the Invention

The present invention relates to a deep sleep battery wake-up system. More particularly, the present invention relates to the design, circuitry and component usage that enables smart battery systems to extended charge retention while in long term storage and when a vehicle is not in use by automatically entering into a deep sleep mode where all quiescent current drain of the internally battery is essentially eliminated.

### 2. Description of Related Art

A battery is normally created by connecting low voltage cells in series. For example, a 12-volt dc vehicle battery is created by connecting six 2-volt dc battery cells in a series string. A modern aircraft battery (24-volts dc) requires twelve lead acid cells, or twenty Ni-Cad or Nickel Metal Hydride (NiMH) cells providing 1.2-volts per cell. The problem with having cells in series is that if any one of the cells fails “open” (disconnected) from the string of cells, the battery ceases to function. If a cell becomes shorted the battery may still function, but it will be one cell short in voltage and will eventually fail to start an engine. In the reliability world these failures are referred to as “single point failures”.

Some devices and systems require “uninterruptible” power supplies to assure operation of a supply-supported device. Conventional charge/discharge circuits require a hands-on physical removal of a battery from its receptacle to test its health, i.e., in a battery tester.

In many applications a battery is needed as a back-up to provide power to essential equipment (sometimes life-saving equipment in the event the primary power source fails). In such cases it is the battery must have high enough reliability to preclude a failure from occurring. One way to increase the probability of having a battery working is to add a second battery in the event the first battery should fail but such addition does not increase the life of either battery. Lead acid batteries are particularly susceptible to “sudden failure” once they have reached between 2 and 4 years of service; and thus, are infamous for “sudden death” occurrences. Nearly everyone who owns a car has experienced the “sudden death” of a vehicle lead acid battery.

It is the general object of this invention to provide a rechargeable battery circuit, multi-battery rechargeable power supply and electronic device that includes the circuitry and/or power supply that are able to selectively test for a battery's present or missing state without disconnecting the battery from its in-circuit battery discharge path and communicating the test results.

Another object of the present invention is to provide a battery circuit having a deep sleep wake-up subcircuit utilizing a vibration and/or motion detector.

A further object of the invention is to provide a method by providing a deep sleep wake-up for reducing occurrences of sudden death in NiMH, NiCad, lead acid and other types of batteries.

Other objects, features and advantages of the present invention will be apparent to those skilled in the art from the following detailed description of the invention taken in conjunction with the drawings.

### SUMMARY OF THE INVENTION

One aspect of this invention relates to Nickel Metal Hydride-low self-discharge battery chemistry, used in combination with an existing technical method, resulting in a new highly reliable battery. Additionally, the invention provides “modularity” to the construction of the battery. A module (providing 12-volt de output) consists of NiMH-LSD AA cells, a built-in charger and battery health monitor sub-circuit. The plug-in modules are in parallel and can be additive, as needed, to supply the amount of current required for the power (in ampere hours) rating of the battery. The safety of the system is that a module could fault, but there are enough modules left to have normal battery function. The failed module can be replaced later and removing the battery is not necessary.

The following are details describing the design, circuitry and component usage that enables smart battery systems (batteries that employ internal electronic circuitry to manage charging, state of charge monitor/display, safety/health monitoring and control operational modes/functions) to extended charge retention while in long term storage and when a vehicle is not in use by automatically entering into a “deep sleep” mode where all quiescent current drain of the internally battery is essentially eliminated. The design incorporates use of a detection device and circuitry that causes the battery to exit deep sleep mode through detection of minute physical motion/vibration.

### BRIEF DESCRIPTION OF THE DRAWINGS

Having described the invention in general terms, reference will now be made to the accompanying drawings, which are not necessarily drawn to scale and wherein:

FIG. 1 is a schematic diagram of an assembled NiMH smart battery circuit having a deep sleep wake-up subcircuit of the present invention;

FIG. 2 is a schematic diagram of a first embodiment of the deep sleep/wake-up sub-circuit of the present invention; and

FIG. 3 is a diagram of a second embodiment of the vibration/motion wake-up sub-circuit of the present invention connected to the smart battery circuit.

### DESCRIPTION OF THE PREFERRED EMBODIMENT(S)

The present invention now will be described more fully hereinafter with reference to the accompanying drawings, in which preferred embodiments of the invention are shown. This invention may, however, be embodied in many different forms and should not be limited to the embodiments set forth herein; rather these embodiments are provided so that this disclosure will be thorough and complete and will fully convey the scope of the invention to those skilled in the art. Like numbers refer to the elements throughout.

While this invention is focused on solving the problems of lead acid batteries, the invention is applicable to all battery chemistries, especially NiMH batteries. One of the primary problems of lead acid (short operating life) is inherent to the chemistry itself. This problem is resolved by replacing the lead acid battery with a Nickel Metal Hydride Low Self Discharge (NiMH-LSD) battery. This alone increases the life of a vehicle battery by a factor of approximately five times. The invention also decreases battery weight by a minimum of two times (18 lbs vs 42 lbs) and volume by approximately twenty percent.

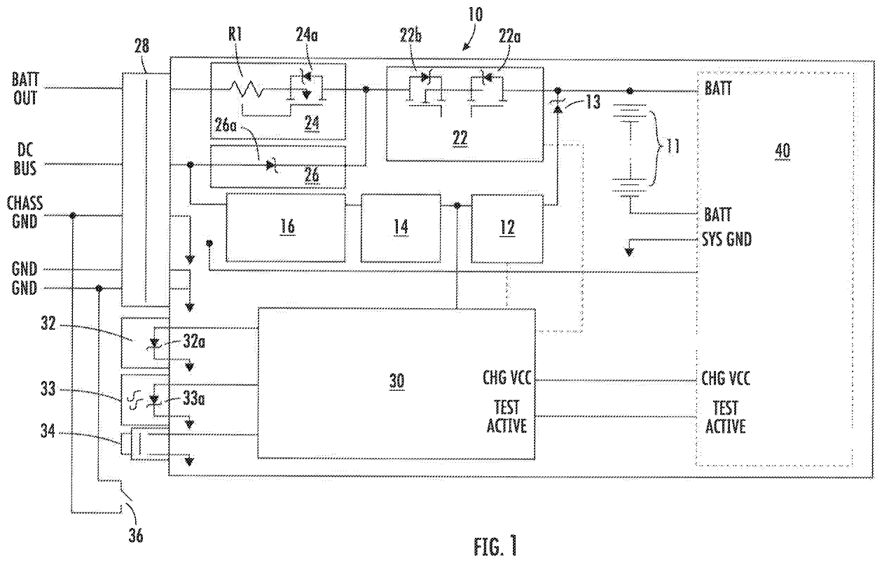

FIG. 1 illustrates an assembled NiMH smart battery charge/discharge circuit 10 having a plurality of battery cells 11 in series, a battery health control/monitoring sub-circuit 30, connected to deep sleep wake-up sub circuit 40. The smart battery circuit 10 is constructed and arranged for maintaining at least two batteries cells 11 in a ready discharge state. Of course, the smart battery circuit 10 may operate upon any number of batteries cells, or battery receptacles, and is not limited to the two-battery configuration depicted in FIG. 1. The smart battery circuit 10 includes a battery plus terminal (for battery discharge or sourcing operation), and a battery minus terminal (for battery charging). The plus terminals of battery cells 11 connect to a positive battery receptacle terminal of each battery receptacle wired in-circuit in the parallel circuit configuration. The positive battery receptacle terminals physically hold each battery cell 11 in place in the circuit and electrically connect to anode electrodes of batteries when physically present in a receptacle.

Each string of battery cells 11 is connected to a mosfet device 13 at its output that does not create voltage drop losses. The purpose of the mosfet is to allow each string to output their voltage and current, and at the same time isolating each from another so that reverse current cannot take place. Otherwise, if reverse current were allowed, cell damage could take place to both the receiving string as well as the feeding string of cells.

Battery charger 12 powered from the vehicle voltage generator is provided and is connected through the mosfit 13 to each module of battery circuit 10. Connected to the charger is boost mode converter 14. Any surges to battery charger 12 are protected by EMI/RFI/transient conditioner 16, which is connected to the line to pass through diode 26, as shown in FIG. 1. If the battery circuit 10 needs to be shut off voltage cutoff switch 22 incorporating mosfits 22a and 22b is connected to the line leading to the battery cells 11. In the case of an over charge, over voltage current detector 24 having mosfit 24a and resistor R1 is provided to reduce occurrence of an overvolting due to the assembled battery cells 11. Over voltage current detector 24 is connected to the cutoff switch 22. The pass-through diode 26 having mosfit 26a is connected to the line connecting the cutoff switch 22 and the over voltage current detector 24. Lines to the over voltage current protector 24, the pass-through diode 26 and the EMI/RFI/transient conditioner 16 are each connected to external connector 28.

The smart battery circuit 10 includes a control/monitor 30 to monitor and control the assembled battery cells 11. The controller/monitor 30 performs balancing control for controlling the amount of discharge from each of the battery cells 11 so that the charge is equalized among the battery cells 11, and thus the amount of discharge from each of the battery cells 11 is adjusted. The control/monitor 30 is connected to the positive electrode side of the battery cells 11 through the line connecting the boost mode converter 14 to the charger 12. The battery monitoring system includes a protection circuit (charge indicator 32 having diodes 32a and 32b).

The present invention includes apparatus and a method for the smart battery circuit 10 to enter into and exit out of deep sleep mode automatically. The smart battery circuit 10 including battery cells 11 is coupled to vibration and/or motion detection wake up sub-circuit 40. The deep sleep feature provides a long shelf life for a battery system thereby minimizing installation pre-charging, premature battery over-discharge, damage/cycle life wear and facilitates immediate installation and dispatch upon receipt. This design feature employs a discrete multi-axis vibration sensor or rudimentary accelerometer/motion sensor 42 input to wake a battery from its deep sleep mode through minute physical movement.

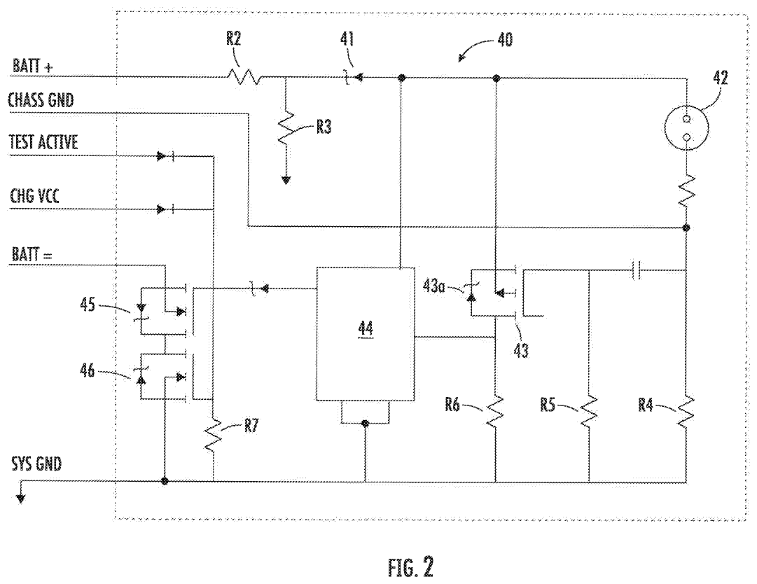

In FIG. 2 there is shown a deep sleep sub-circuit 40 for use with the smart battery charge/discharge circuit 10. The configuration, as shown in FIG. 2, consumes 0.9 μA in deep sleep. The positive terminal of battery cell 11 is connected to a vibration sensor 42. An example of a multi-axis vibration sensor for use with this invention is the SQSEN-200 nano power tilt and vibration sensor by SignalQuest. When at rest the sensor normally settles in a closed state. When in motion, the vibration/motion sensor 42 produces continuous on/off contact closures. It is sensitive to both tilt (static and acceleration) and vibration (dynamic acceleration). Another suitable micro vibration sensor for use in the deep sleep sub-circuit is the VS 1 by Sensolute.

The vibration or motion detection deep sleep wake up circuit 40 includes vibration sensor. 42, as well as a conditional circuit 44 and a deep sleep battery low cutoff switch 43 that includes mosfit 43a. The vibration or motion detection wake up circuit 40 additionally may include a small battery that draws a small amount of current from the battery or rows of batteries when the system is asleep. A small draw, (e.g., less than 1 microampere), is adequate to help prevent dead starts associated with prolonged periods of nonuse. In this manner, the battery circuit 10 may remain at a usable voltage even when not in use.

According to this embodiment, the battery circuit 10 may be awakened from an ultralow quiescent power mode or deep sleep mode. The battery circuit 10 may enter deep sleep mode after approximately two minutes of activity depending upon the configuration of the setting for the timer 44. Inactivity may be detected using detection of motion, charge power, load application, for a discrete input, among other inputs. While asleep, the cutoff switch 43 of vibration motion detection circuit 40 isolates the battery cell's negative terminal from the system ground and lower the quiescent current drain to less than one microampere. For example, the system battery voltage may be approximately 28-volts to 5-volts and be supplied to the vibration/motion sensor 42. With no motion, the vibration/motion detection wake up circuit 40 may output a five-volt signal.

The circuit may close the switch 43 and initiate a two-minute motion activity timer. If motion or other activity is detected before the two-minute timer expires, the period may be reset for another two minutes. After the two-minute timer expires, the system returns to sleep mode. The vibration and motion sensor 43 may extend battery long lifelong term storage charge retention and minimize maintenance and reliability issues. The deep sleep/wake-up circuit 40 may draw a low, negligible current that is employed to use of the vibration motion sensor.

The deep sleep/wake-up circuit 40 is connected may be to the battery sleep/wake circuit 10 which may be similar to or identical to the circuit 10 of FIG. 1. The deep sleep wake-up sub-circuit 40 employs dual N-channel mosfets 45, 46 in a common drain configuration to isolate the battery negative from system ground; thereby, putting the battery pack into nano-power quiescent drain mode.

The deep sleep/wake-up circuit 40 utilizes along duration nano-power timer circuit 44 that establishes the duration of the awake cycle. As shown in FIG. 2 the timer is a TLP5111 timer. Timer circuit 44, as described in this embodiment, is configured for an awake duration of 2 minutes, but can be configured from milliseconds to hours. When activated, timer circuit 44 closes the N-channel mosfets 45, 46 and the system output is active (awake). Normally, the vibration sensor is at rest, logic high and the battery is in sleep mode and provides no output (sleep). When vibration sensor 42 detects any movement, it produces a momentary logic low that triggers the timer to activate and enable the battery cell to wake-up for 2 minutes, after which, deep sleep/wake-up circuit 40 reverts to sleep mode. The deep sleep/wake-up circuit 40 includes appropriate resistors, for example, battery positive R2 and ground resistors R3-R7.

As shown in FIG. 1, three discrete signals are employed to disable sleep mode to ensure the battery output is available to power in emergency back-up function. These discreet signals include: DC bus input activation, front panel Level Test Switch 33 and provisional Discreet Wake Signal input (switch 36 having mosfit 33a) (external wire harness chassis to system ground short). These discreet signals may be controlled by test indicator switch 36. The front panel level test switch and the DC bus present signal are active high signals that command the N-channel mosfets to close and the battery system to remain awake. The external wire harness chassis to system ground short input is active low and is connected to the motion sensor output. When this signal is active (low), it commands the sleep timer circuit 44 to remain in the awake state. The design of discrete accelerometer circuitry does not incorporate use of a microcontroller or microprocessor; therefore, will not add any significant quiescent power above the natural cell chemistry self-discharge rate or require exhaustive and expensive software qualification testing.

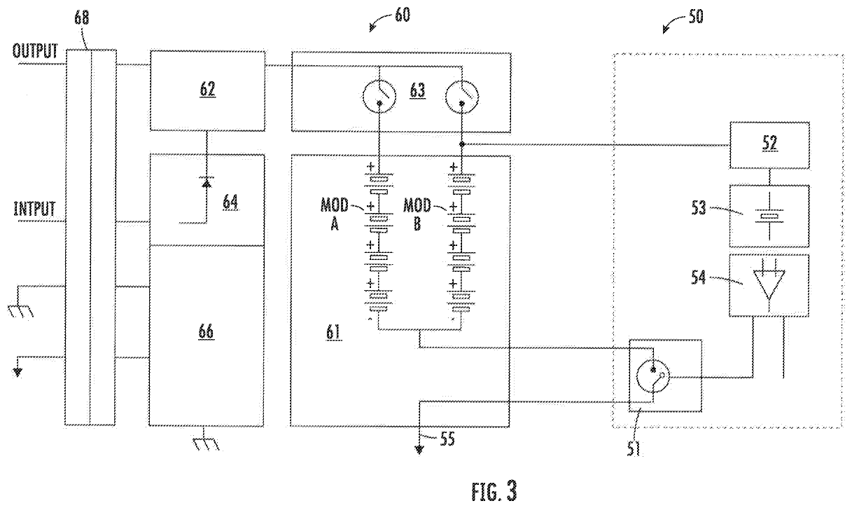

In FIG. 3 there is shown another vibration/motion detection wake-up sub-circuit 50 connected to smart battery charge/discharge circuit 60 from ultra-low quiescent power mode or deep sleep mode. The smart battery charge/discharge circuit 60 will enter into deep sleep mode after approximately 2 minutes of inactivity (motion, charge power, load application, discreet input, etc.). The battery circuit 60 includes dual strings of battery cells 61, module A and module B. Power path switches 63 connect the battery cells 61 to battery charger 62 which in in turn connected to external connector 68. Any surges to battery charger 62 are protected by EMI/RFI/transient connector 66.

While asleep, deep sleep low battery switch 51 is open isolating the battery negative terminal from system ground 55 and lowering quiescent current drain to, 1 μA. The system battery voltage is converted from approximately 28-volts to about 5-volts by converter 52 and supplied to vibration sensor 53. With no motion vibration sensor 53 outputs a 5-volt high signal. When the battery system is moved vibration sensor 53 outputs a momentary low signal to nano-power vibration sensor conditioner/amplifier circuit 54. Vibration sensor conditioner/amplifier circuit 54 will close deep sleep low battery switch 51 and initiate a 2-minute timer. If input/motion activity is detected before the 2-minute timer expires, the timer 64 will be reset for another 2 minutes. After the 2-minute timer expires with no activity, deep sleep low battery switch 51 will open and the system will return to sleep mode.

When paired with the low self-discharge rate demonstrated by modem NiMH-LSD (Nickle Metal Hydride-Low Self Discharge) type cells, the combination will yield an unprecedented near five year shelf storage charge retention (i.e., direct installation/deployment with no pre-conditioning). NiMH-LSD chemistry provides the added benefit of allowing shipment of fully charged batteries (permitting direct installation upon receipt), no DG (Dangerous Goods) or Hazmat (Hazardous Materials) regulations and none of the regulatory restrictions associated with SLA (Sealed Lead Acid), NiCad (Nickle Cadmium) or Lithium Based Chemistries.

The present invention has smart battery health monitoring provisions which can indicate the battery failure by an audible, LED indication and/or wireless transmission to a smart phone device. The energy level of the battery is available by the press of a battery push button and/or wireless connection.

System Sleep Mode Description Table 1

| | | | Control | Quiescent |
|---|---|---|---|---|
| Mode | Configuration | Sensor State | Input | Current |
| Deep Sleep | No attached | No Motion | Motion | 0.9 μA |
| | wiring/ln long | Detected- | sensor- | |
| | term storage | Continuous | inactive | |
| | | Logic HIGH | | |
| Awake Until | No attached | Motion | Motion | 550 uA |
| Sleep Timer | wiring/ln long | detected- | sensor- | Changing |
| Expires | term storage | Multiple | active | to 0.9 μA |
| | | Momentary | | |
| | | Logic LOW | | |
| | | signals | | |
| Awake Until | No attached | N/A | Test Switch | 550 μA |
| Sleep Timer | wiring/stored | | Activated | Changing |
| Expires | | | | to 0.9 μA |
| Awake | Wiring | N/A | Installed | 550 μA + |
| | attached/ | | Wake signal | Load |
| | installed/Bus | | Active | |
| | inactive | | (Armed) | |
| Awake Until | Wiring | N/A | Installed | 550 μA |
| Sleep Timer | attached/ | | Wake Signal/ | Changing |
| Expires | Installed/Bus | | Switch | to 0.9 μA |
| | inactive/arm | | opened | |
| | switch open | | (disarmed) | |
| Awake | Wiring | N/A | Bus Present | 550 μA + |
| | attached/ | | (ChgVcc | Load |
| | Installed/Bus | | Active, | |
| | active | | internal | |

Many modifications and other embodiments of the invention set forth herein will come to mind to one skilled in the art to which the inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for the purpose of limitation.

What is claimed is:

1. A smart battery monitoring system having a deep sleep wake-up feature comprising:
a smart battery circuit comprising a string of battery cells connected to a mosfit, a battery charger connected through said mosfit to each string of battery cells and including at least an EMI/RFI transient conditioner, a cutoff switch, and an over voltage connector connected to an over voltage current detector;
a control/monitoring sub-circuit for controlling and monitoring said string of battery cells, said control/monitoring sub-circuit controlling the amount of discharge from each of the battery cells so the charge is equalized among the battery cells and further said control/monitoring sub-circuit being connected to the positive electrode of the battery cell; and
a deep sleep wake-up sub-circuit connected to said smart battery circuit including a vibration/motion detector wherein said deep sleep wake-up sub-circuit is capable of waking up said smart battery circuit from a deep sleep.

2. The vibration/motion sensor according to claim 1 wherein said deep sleep wake-up sub-circuit comprises:
a multi-axis vibration/motion sensor connected to the positive anode of said battery cells;
a conditional circuit including a timer connected to said multi-axis vibration/motion sensor and responsive thereto; and
a deep sleep battery low cutoff switch capable of isolating the battery cell negative terminal.

3. The multi-axis vibration sensor according to claim 2 wherein said timer is a long duration nano-power timer configured for an awake duration from milliseconds to hours.

4. A deep sleep wake-up sub-circuit connected to said smart battery circuit comprising:
a vibration/motion detector wherein said deep sleep wake-up sub-circuit is a deep sleep wake-up sub-circuit connected to said smart battery circuit including a vibration/motion detector wherein said deep sleep wake-up sub-circuit is capable of waking up the smart battery circuit from a deep sleep;
a conditional circuit including a timer connected to said multi-axis vibration/motion sensor and responsive thereto;
a deep sleep battery low cutoff switch capable of isolating the battery cell negative terminal and;
wherein said deep sleep wake-up sub-circuit is capable of waking up said smart battery circuit from a deep sleep.

5. The multi-axis vibration sensor according to claim 4 wherein said timer is a long duration nano-power timer configured for an awake duration from milliseconds to hours.

6. A method of managing a battery system, the method comprising:
providing a smart battery circuit comprising a string of battery cells connected to a mosfit, a battery charger connected through said mosfit to each string of battery cells and including at least an EMI/RFI transient conditioner, a cutoff switch, and an over voltage connector connected to an over voltage current detector; a control/monitoring sub-circuit for controlling and monitoring said string of battery cells, said control/monitoring sub-circuit controlling the amount of discharge from each of the battery cells so the charge is equalized among the battery cells and further said control/monitoring sub-circuit being connected to the positive electrode of the battery cell;
providing a deep sleep wake-up sub-circuit connected to said smart battery circuit including a vibration/motion detector wherein said deep sleep wake-up sub-circuit is capable of waking up said smart battery circuit from a deep sleep; and
sensing a period of inactivity of said string of battery cells that is in electrical communication with said wakeup circuit; and in response to sensing said period of inactivity actuating a switch in said wakeup circuit to cause said wakeup circuit to draw a current from the battery.

7. The method of claim 6, further comprising closing said wake-up circuit in response to sensing the period of activity.
